(19) United States
(12) Patent Application Publication
(10) Pub. No.: US 2010/0199857 A1
(43) Pub. Date: Aug. 12, 2010

(54) MULTI-ZONE COMPOSITE COOKING GRIDDLE WITH UNITARY THERMALLY CONDUCTIVE PLATE

(76) Inventors: Paul Storiz, Grayslake, IL (US); Sailesh Babu Athreya, Lake Villa, IL (US); Michael Starozhitsky, Long Grove, IL (US); Miguel Espina, Matthews, NC (US); Timothy Welsh, Kirkwood, MO (US)

Correspondence Address: THOMPSON HINE LLP;Intellectual Property Group, P.O Box 8801, DAYTON, OH, 45401-8801, US

(21) Appl. No.: 12/665,062

(22) PCT Filed: Jul. 10, 2007
(86) PCT No.: PCT/IB07/04621

§ 371 Date: Dec. 17, 2009

(30) Foreign Application Priority Data
Jul. 10, 2007 (IB) 2007 004621

(51) Int. Cl. A47J 37/06

(52) U.S. Cl. 99/422

(57) ABSTRACT

A composite cooking structure adapted for use as a griddle top, presenting a plurality of thermally autonomous cooking zones when engaged by at least one heat source, and having a multi-layered configuration, including an uppermost hard planar member for presenting a cooking surface, a unitary thermally conductive planar member defining at least one thermal break for improving heat distribution within a zone and reducing thermal bleeding among adjacent zones, and preferably a lowermost hard planar member for improving the structural capacity of the structure, wherein the members are preferably metallurgically bonded and the thermal breaks cooperatively define the zones.

### CROSS REFERENCE TO RELATED APPLICATION

The present application claims priority from U.S. Provisional Patent Application Nos. 60/819,679 and 60/842,412 of Storiz et al, filed 10 Jul. 2006 and 5 Sep. 2006, respectively, the disclosures of which are hereby incorporated herein by reference.

### BACKGROUND OF THE INVENTION

1. Field of the Invention

The present invention relates to cookware and cooking appliances. More particularly, the present invention concerns a multi-zone composite cooking griddle formed of a plurality of unitary layers, and configured to provide a plurality of thermally autonomous cooking zones.

2. Discussion of Prior Art

In order to provide the necessary hardness and resistive characteristics of a cooking surface, conventional cooking griddles are generally made with a thick low carbon steel plate. Typical griddle cooking configurations include plural sets of burners that are oriented beneath and separably operable to heat an equal plurality of sectors of the plate. It is the intent of the plural arrangement to present a plurality of thermally autonomous zones across the griddle surface, wherein each zone presents an individually heated and cooled sector that exerts minimal thermal influence upon adjacent zone(s). Unfortunately, because steel presents low thermal conductivity, these types of griddles have proven incapable of providing a uniform temperature across the griddle surface or within an individual temperature zone. The portion of each zone in direct engagement with the heat source typically becomes much hotter than the corners or distal regions of the zone. While some newer griddles have used steam heating to improve the temperature variations, it is difficult to apply this technology to a multiple zone griddle.

As a result, composite cooking griddles have more recently been developed to improve heat distribution throughout the cooking surface and heat recovery when a cold load is applied to the surface. These types of griddles utilize a thin steel or stainless steel cooking surface and at least one thermally conductive plate attached below the top surface to provide a more uniform cooking griddle. In this configuration, upon engagement with a heat source, the lateral flow of heat energy across the thermal conductive plate outpaces heat transfer from the thermal conductive material to the steel. As a result the upper steel cooking surface is more uniformly engaged by the heat source.

The improved lateral flow of heat energy offered by conventional unitary thermally conductive layers, however, present concerns relating to thermal bleeding (i.e., the undesired transmission of heat energy into untargeted adjacent zones), which may result in uneven cooking and therefore a dysfunctional cooking apparatus. It is further appreciated that treating the entire cooking surface with heat energy, when only a portion of the surface is utilized, results in inefficiencies relating to energy consumption. To counteract these concerns, thermally conductive members are often dissevered into a plurality of individually spaced sub-plates, as shown in prior art FIG. 1. Unfortunately, however, with the introduction of multiple spaced apart thermally conductive sub-plates, significant increases in costs associated with manufacturing and construction are experienced. For example, each sub-plate must be laboriously oriented, positioned, and then attached beneath the upper steel layer at precise relative spacing, so as to produce the thermal breaks therebetween. Moreover, prior art griddle tops having multiple sub-plate thermal conductive layers are also problematic in that severing the layer results in decreased structural capacity. Consequentially, these types of composite cooking structures have not been profusely implemented, and have achieved low market penetration.

Thus, there remains a need in the art for a more facilely manufactured and constructed composite cooking structure that provides thermally autonomous cooking zones to address concerns relating to thermal bleeding.

### SUMMARY OF THE INVENTION

Responsive to these and other concerns, the present invention presents a composite cooking griddle that combines the efficiency and structural advantages of unitary layer construction with the benefits of thermally autonomous zones. To that end, the inventive composite structure includes a unitary thermally conductive member that defines at least one thermal break. The invention is useful, among other things, for providing a more facilely manufactured and constructed composite cooking structure, and a structure having a thermally conductive layer configured to provide more uniform heat distribution within zones and faster recovery from cold loads applied to the cooking surface. Despite the unitary layer construction of the thermally conductive layer, the present invention maintains the advantages and efficiencies presented by multi-thermal zone cooking. Thus, a more easily manufactured and constructed multiple zone griddle is presented for simultaneously cooking a variety of foodstuffs, such as hamburgers, steaks, eggs, etc. with a uniform temperature distribution within each zone.

More specifically, the present invention concerns a composite cooking structure adapted for use as a griddle top, and presenting a plurality of thermally autonomous cooking zones when engaged by at least one heat source. The structure includes a plurality of hard planar members each presenting first top and bottom major surfaces separated by a first thickness, and having a first thermal conductivity rate. The composite structure further includes at least one thermally conductive planar member presenting second top and bottom major surfaces separated by a second thickness greater than the first thickness, having a second thermal conductivity rate greater than the first rate, and defining at least one elongated thermal break opening presenting a minimum depth not less than 75 percent of the second thickness. The hard and thermally conductive members are intermittently reposed and configured to form superjacent major layers having an uppermost and a lowermost surface, wherein the top surface of each of said at least one thermally conductive planar member contacts and engages the bottom surface of an aloftly adjacent hard member, so that a hard member presents the uppermost surface. Finally, the opening is longitudinally configured to produce generally separate first and remainder sections of the thermally conductive member, so that the heat source is able to separately engage the sections.

A second aspect of the invention concerns a method of constructing the composite structure. The method includes the not necessarily sequential steps of securing the first stainless steel sheet, machining at least one elongated opening within the thermally conductive planar member, wherein the opening presents a depth at least 75 percent of the second thickness, securing the thermally conductive planar member adjacent the sheet such that the second top major surface engages and forms superjacent layers with the first bottom surface, and securing a second stainless steel sheet presenting third top and bottom major surfaces spaced by a third thickness equal to the first thickness adjacent the member such that the third top surface engages and forms superjacent layers with the second bottom surface.

Other aspects and advantages of the present invention, including suitable and preferred material compositions, suitable and preferred methods of forming the openings, and suitable and preferred methods of bonding the members will be apparent from the following detailed description of the preferred embodiments and the accompanying drawing figures.

### BRIEF DESCRIPTION OF DRAWINGS

Preferred embodiments of the invention are described in detail below with reference to the attached drawing figures, wherein:

FIG. 1 is a perspective cross-sectional view of a prior art composite cooking structure adapted for use as a griddle top, particularly illustrating separate thermally conductive sub-plates;

FIG. 2 is a perspective view of a composite cooking structure having a unitary thermally conductive plate in accordance with a preferred embodiment of the present invention, and a mated griddle cooking apparatus;

FIG. 2a is an inset of FIG. 2, particularly illustrating the cooking surface and multi-layers of the composite cooking structure;

FIG. 3 is a perspective cross-sectional view of the composite cooking structure shown in FIG. 2, particularly illustrating an upper hard member, intermediate thermally conductive member and a lower hard member cooperatively defining a plurality of three thermal break openings;

FIG. 3a is a segmental view of the 3-layer structure shown in FIG. 3;

FIG. 4 is an exploded view of a composite cooking structure in accordance with a preferred embodiment of the invention, wherein the openings are spaced from the edges of the thermally conductive member and filled with an insulative material (shown typically);

FIG. 5 is a perspective view of a thermally conductive plate in accordance with a preferred embodiment of the present invention, wherein full depth openings are spaced from the edges of, a plurality of intermediate ligaments traversing the openings are defined by, and a resistance heat element is integrally formed within the thermally conductive member;

FIG. 6 is an exploded view of a 5-layer composite cooking structure in accordance with a preferred embodiment of the present invention, particularly illustrating a plurality of thermally conductive members having full depth thermal break openings shown extending along only a portion of the member width, and proposed thermo-couple slots (shown in hidden-line type);

FIG. 7 is a perspective cross-sectional view of a composite cooking structure in accordance with a preferred embodiment of the invention, particularly illustrating upper and lower hard members, and a plurality of through-hole thermal break openings bored within, and spaced from the major surfaces of, the thermally conductive member;

FIG. 8 is a bottom view of a circular thermally conductive plate in accordance with a preferred embodiment of the invention, particularly illustrating circular thermal break openings and radially defined autonomous zones; and

FIG. 9 is a bottom view of a square thermally conductive plate in accordance with a preferred embodiment of the invention, particularly illustrating continuous square thermal breaks filled with an insulative material.

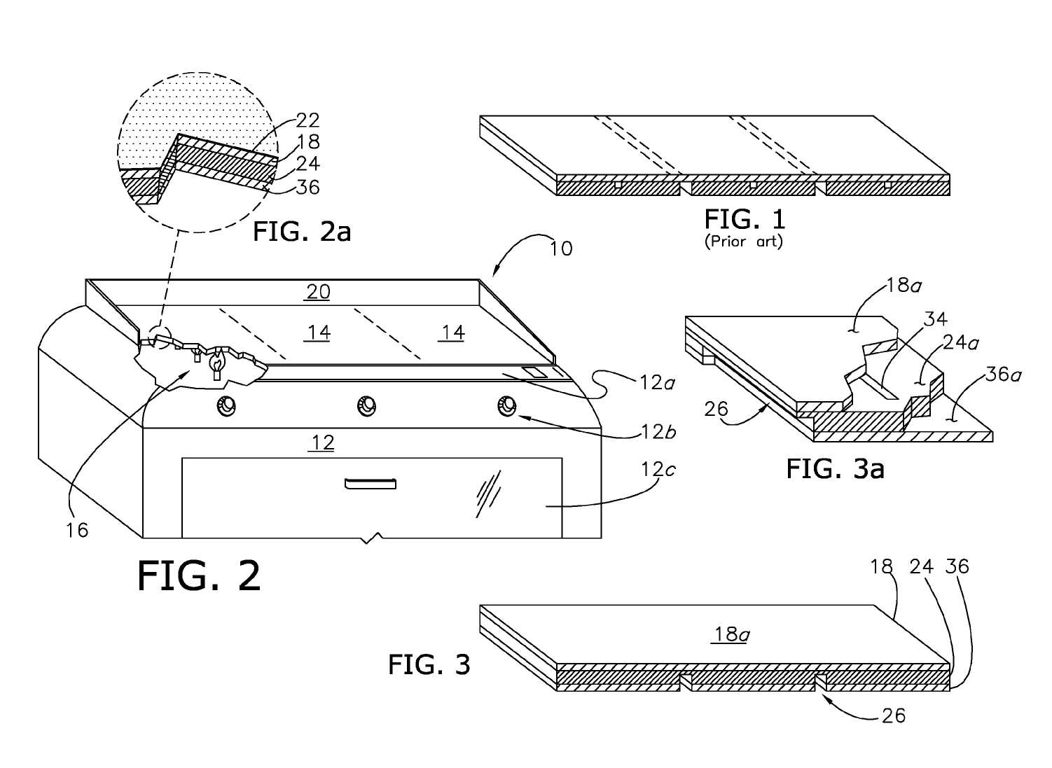

### DETAILED DESCRIPTION OF THE PREFERRED EMBODIMENT(S)

As illustrated and described herein, the present invention relates to a composite cooking structure 10 adapted for use as a griddle top, and with a griddle cooking apparatus 12 (FIG. 2). The inventive structure 10 presents a plurality of thermally autonomous cooking zones 14 when engaged by at least one heat source 16. The apparatus 12 and heat source 16 are exemplarily described and illustrated herein; however it is appreciated by those of ordinary skill in the art that the features and advantageous of the present invention can be used with other apparatuses and/or heat sources. For example, the illustrated apparatus 12 presents, but need not necessarily include, a grease trough and outlet 12a mating the front edge of the structure 10, a plurality of temperature control knobs 12b for actuating a plurality of heat sources 16, and an access/oven door 12c. Preferred material composition and methods of making the invention are described herein, with the understanding that relevantly equivalent materials and methods could be utilized instead, and are well within the ambit of the present invention.

Turning to the configuration of the present invention, the composite structure 10 includes a relatively thin hard planar member 18 that forms the uppermost layer or top plate thereof. As shown in FIGS. 2-7, the uppermost hard planar member 18 presents a rectangular plate having top and bottom major surfaces 18a,b spaced by a first thickness preferably between 0.030 to 0.090 inches (i.e., 0.08 to 0.23 cm), and more preferably between 0.040 to 0.070 inches (i.e., 0.1 to 0.18 cm). The uppermost member 18 preferably presents conventional cooking dimensions and, for example, may define a length 48 in. (i.e., 71 cm) and a width of 24 in. (i.e., 56 cm). The top major surface 18a of the uppermost hard member 18 presents a durable cooking surface and is therefore configured to withstand the anticipatory mechanical forces typically associated with cooking and cleaning, including scraping and scrubbing with hand utensils such as metal spatulas and pads. As shown in FIG. 2, the preferred uppermost member 18 presents a side and rear splash-guard 20. The top plate 18 and splash-guard 20 may be integrally formed, so as to present one solid piece with large radii. It is appreciated that this eliminates seams and crevices, wherein food and other substances could become entrapped.

The preferred uppermost hard member 18 is further configured to resist corrosive and oxidizing agents, such as water, cooking fluids, foodstuffs, and chemical cleaning agents, including oils, fats, and acids. As such, the preferred uppermost hard member 18 consists essentially of a material of suitable hardness (“i.e., resistance to plastic deformation, usually by indentation, and to scratching, abrasion, or cutting), and more preferably to a material presenting a minimum hardness value, such as, for example, a Brinell hardness value greater than 200. It is appreciated that certain conventional annealing treatments may result in reduced material hardness at the surface and near-surface regions. Nevertheless, a suitable material composition for the hard member 18 is Type 304 Stainless Steel, which has an unannealed Brinell hardness number of 201. Alternatively, other austenitic grades of steel, such as Type 201, ferritic stainless steel grades 430, 439, 441, or other materials such as titanium may be utilized. The uppermost hard member 18 may further present a protective, or non-stick layer 22, as is desired.

The composite structure 10 further includes a relatively thicker thermally conductive member 24 attached to the bottom surface 18b of the uppermost hard member. The thermally conductive member 24 presents a unitary rectangular body that preferably matches the upper hard member 18 in length and width, and therefore presents top and bottom major surfaces 24a,b that match the uppermost member surfaces 18a,b. It is appreciated that the unitary nature of the thermal member 24 streamlines manufacturing and construction. More particularly, the thermal member 24 presents a thickness greater than the thickness, and more preferably greater than two times the thickness of the hard member 18. For example, the thermal member 24 may present a thickness of 0.35 to 1 inch (i.e., 0.9 to 2.5 cm), and more preferably, a thickness of 0.35 to 0.65 inches (i.e., 0.9 to 1.7 cm). The member 24 is formed of material having a minimum thermal conductivity, more preferably a conductivity greater than 150, and most preferably greater than 200 Btu/ft-hr-F. For example, the thermal member 24 may be formed of aluminum, aluminum alloys, copper, copper alloys or other equivalent thermally conductive metals, and more preferably consists essentially of a 1100 series aluminum. The function of the thermal member 24 is to store heat and distribute the heat uniformly within a temperature zone by maintaining a high heat transfer rate laterally.

A novel aspect of the invention involves the formation of thermally autonomous zones 14 by a unitary thermally conductive member. As best shown in FIGS. 3-9, each thermal member 24 defines at least one thermal break opening (or slot) 26. The zones 14 are defined in part by the thermal breaks 26. There are no requirements of thickness with respect to the thermal breaks 26, as long as they separate the zones 14 by temperature. Nevertheless, the preferred width of the thermal breaks in the illustrated embodiment is between 0.25 to 0.5 inches (i.e., 0.63 to 1.27 cm). In order to isolate each zone 14, the thermal breaks 26 are machined (i.e., by cutting, shearing, shaving, or other mechanized method of material removal) into the bottom surface 24b of the thermal member 24. Alternatively, the slots 26 may be gun drilled from an edge.

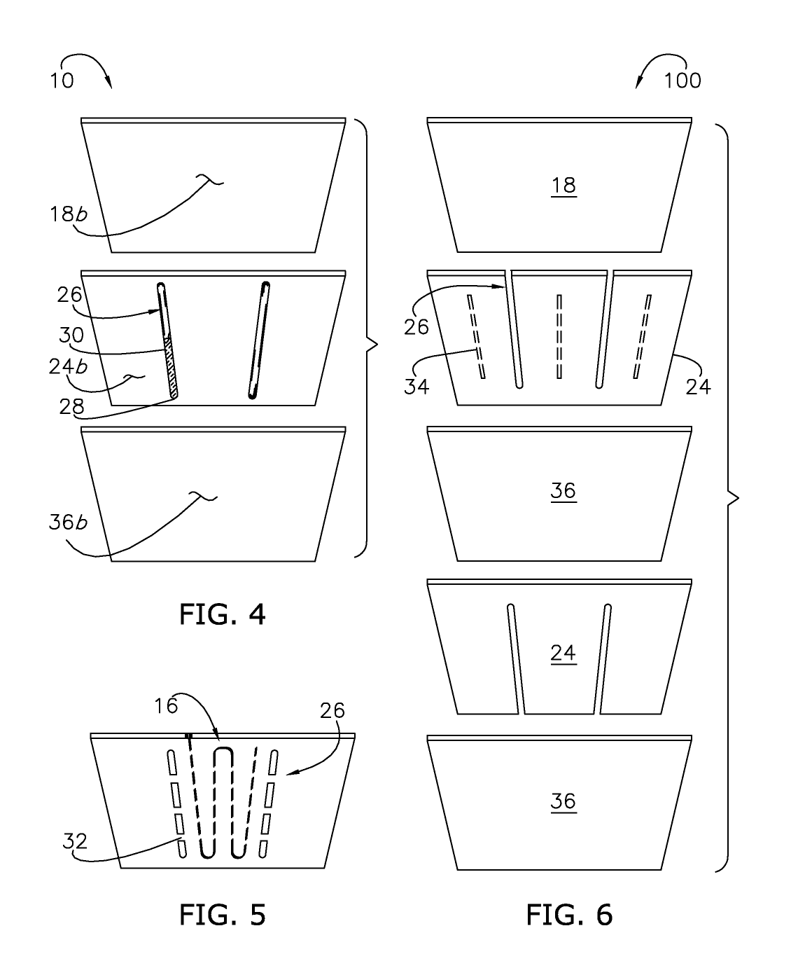

The preferred openings 26 present elongated slots that are cut longitudinally into the bottom of the member 24. Each opening 26 preferably presents a depth at least 50 percent, and more preferably a depth at least 75 percent of the thermal member thickness. A depth less than 100 percent, and more preferably, less than 90 percent of the thermal member thickness is provided, where the opening 26 is to be spaced from the top engaging surface of the thermal member 24. In this configuration, it is appreciated that the opening 26 may extend the entire width of the member 24, and that the full area of the top major surface 24a is available for engagement. More preferably, however, the opening 26 is offset from each edge of the member 24, so as to present distal structural ligaments 28 that increase the structural integrity of the plate 24. Finally, the interior space defined by each opening or slot 26 is preferably filled with a thermally insulative material 30 to further prevent both conductive and convective heat transfer (FIGS. 4 and 9). Materials such as low conductivity metals, fiberglass, ceramic, silica fibers, fabrics or cloths, for example, may be utilized. The material 30 may be flexible or rigid, and secured by press fitting, with high temperature adhesives, or by mechanical means. The preferred material 30 is a fiberglass knitted rope material that is press fitted into the slots 26.

As shown in FIG. 5, at least one intermediate ligament or brace 32 may be further defined by the thermal member 24 to provide added structural capacity with respect to bending, torsional and warping loads. In this configuration the thermal breaks 26 are bifurcated or further sectioned so as to result in a plurality of end-to-end sub-slots sharing a common longitudinal axis. The preferred length of the intermediate ligaments is between 0.5 to 1.5 inches (i.e., 1.27 to 3.81 cm) and more preferably 1 inch (i.e., 2.54 cm). At these lengths, it is appreciated that the additional heat travel to the adjacent zones is insignificant. Each sub-slot may also be filled with insulative material 30. Finally, and as also shown in FIG. 5, it is within the ambit of the invention for a resistive heat source 16 to be integrally formed within the thermal member 24.

Another embodiment of the thermal breaks 26 is shown in FIG. 6, wherein the slots 26 present full depth openings extend the full thickness of the thermal member 24. To maintain the unitary nature of the thermal member 24, the slots 26, in this configuration, extend for only a portion of the member width. The slots 26 need not extend from an edge, and may be spaced from both edges as previously described. More preferably, the slots extend for a length between 60 to 90 percent of the member width. In a multi-thermal layer configuration, as shown in FIG. 6, sequential thermal layers 24 having full depth slots extending from an edge are preferably rotated, so as to present an angular offset of 180 degrees. It is appreciated that this configuration further reduces thermal bleeding at the cooking surface by providing vertical thermal breaks as well. Also shown in FIGS. 3a and 6, the preferred thermal member 24 may also define thermocouple or sensor receiving cavities 34 along the top surface 24a. As is known in the art, a thermocouple or sensor (not shown) when operably positioned enables accurate cooking surface temperature readings to be taken for a particular zone, which provides feedback and enables closed-loop control.

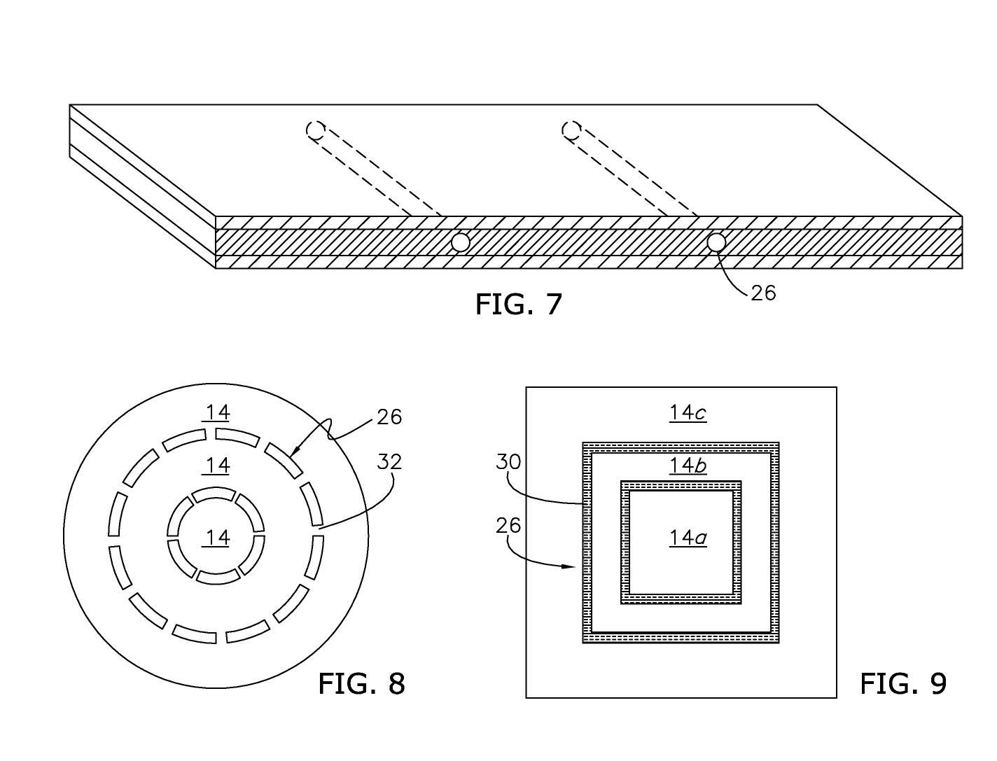

Yet another embodiment of the thermal breaks 26 is shown in FIG. 7, wherein a plurality of through-holes are shown spaced from the top and bottom surfaces 24a,b of the thermal member 24. In this configuration, the breaks 26 present cylindrical bore-holes that may be advantageously formed after the structure 10 has been constructed. Lastly, the breaks 26 need not present linear configurations, and instead may present curvilinear or other alternative configurations, where the resulting thermal zone shapes are desired. For example, as shown in FIG. 8, where the structure 10 presents a circular griddle configuration, the breaks 26 may present circular rings that create radially autonomous zones 14. Similarly, FIG. 9 presents a square griddle configuration having a square interiormost zone 14a, perhaps for cooking, an intermediate zone 14b, perhaps for keeping food warm, and an outer zone 14c, perhaps for consuming.

As a result of differences in thermal expansion between the uppermost hard and thermal members 18,24, the structure 10 preferably includes a third and lowermost layer presented by a second hard planar member 36. Hard member 36 is preferably identical in material composition and in configuration to the uppermost hard member 18, with the exception that the top major surface 36a of the second hard member 36 need not include a non-stick layer or other advantageous cooking surface treatment, or a thermocouple/sensor cavity. The second hard member 36 is fixedly attached to the bottom surface 24b of the thermal member 24 to balance the expansion properties of the structure 10, and improve griddle flatness when heated. More particularly, the second member 36 is configured with respect to material composition and thickness, so as to produce a thermal expansion rate similar to the uppermost hard member 18.

The thermal breaks 26 may be produced prior to joining the second hard member 36, so as to present a symmetrical composite structure 10 having continuous upper and lowermost layers. More preferably, however, and as shown in FIG. 3, pre-form solid uppermost hard, thermally conductive, and second hard members 18,24,36 are roll bonded or interconnected by another process prior to machining the thermal breaks 26. In this configuration, the breaks 26 are additionally cut completely through the second hard member 36. As such, and so as to retain a unitary second hard member 36, this method of construction is not preferred where full width breaks 26 are to be produced in the thermal layer.

Thus, a 3-layer composite structure is presented and shown in FIGS. 2-4, and 7; however, it is certainly within the ambit of the invention for a greater number of alternating layers to be presented. For example, as shown in FIG. 6, another variation of the present invention is a 5-layer structure 100. In this configuration, two thermal members 24 and two second hard members 36 are intermittently reposed beneath the uppermost layer 18, such that the top major surface 36a of every second hard member 36 engages a bottom major surface 24b of a thermal member 24 and the lowermost layer of the structure 100 is a second hard member 36. It is appreciated that the cost of manufacture and construction naturally increases with the addition of repetitive layers, but that thermal bleeding at the uppermost cooking surface is proportionately decreased due to improved temperature uniformity and increased dissipation.

After properly securing the members 18,24,36 and making sure that the surfaces to be joined are free of contamination, high strength bonds between the constituent plates are produced preferably by roll bonding the layers together, so as to create metallurgic bonds therebetween. The individual members 18,24,36 may be pre-treated as desired; for example, it is appreciated that annealing the plates increases their responsiveness to the bonding or adhesion process, and relieves internal stresses. It is also appreciated that roll bonding further provides uniform distribution of heat due to the elimination of air gaps between the members. Alternatively, explosion bonding may be utilized to join the layers, and the upper and lowermost members 18,36 can be further joined by brazing or a soldering process using filler metals. In another alternative, the members 18,24,36 can be fixedly attached to one another using a high temperature adhesive compound (not shown) placed between the surface areas of engagement.

The preferred forms of the invention described above are to be used as illustration only, and should not be utilized in a limiting sense in interpreting the scope of the present invention. Obvious modifications to the exemplary embodiments and methods of operation, as set forth herein, could be readily made by those skilled in the art without departing from the spirit of the present invention. The inventors hereby state their intent to rely on the Doctrine of Equivalents to determine and assess the reasonably fair scope of the present invention as pertains to any system or method not materially departing from but outside the literal scope of the invention as set forth in the following claims.

What is claimed is:

1. A composite cooking structure adapted for use as a griddle top, and presenting a plurality of thermally autonomous cooking zones when engaged by at least one heat source, said structure comprising:
a plurality of hard planar members each presenting first top and bottom major surfaces separated by a first thickness, and having a first thermal conductivity rate; and
at least one unitary thermally conductive planar member presenting second top and bottom major surfaces separated by a second thickness greater than the first thickness, having a second thermal conductivity rate greater than the first rate, and defining at least one elongated opening presenting a depth at least 75 percent of the second thickness,
said hard and thermally conductive members being intermittently reposed and configured to form superjacent major layers having an uppermost and a lowermost surface, wherein the top surface of each of said at least one thermally conductive planar member contacts and engages the bottom surface of an aloftly adjacent hard member, so that a hard member presents the uppermost surface,
said opening being longitudinally configured to produce generally separate first and remainder sections of said at least one thermally conductive member, such that said at least one heat source is able to separately engage the sections.

2. The composite structure as claimed in claim 1, wherein the hard members are formed of material selected from the group consisting essentially of steel, austenitic stainless steel, and Ferritic stainless steel, and the thermally conductive member is formed of material selected from the group consisting essentially of aluminum, aluminum alloys, copper, and copper alloys.

3. The composite structure as claimed in claim 2, wherein the hard and thermally conductive members are roll-bonded together, so as to produce metallurgic bonds therebetween.

4. The composite structure as claimed in claim 1, wherein the first thickness is between 0.030 to 0.090 inches and the second thickness is between 0.35 to 1 inch.

5. The composite structure as claimed in claim 1, wherein the hard members presents a Brinell hardness value greater than 200 max, and each thermally conductive member presents a thermal conductivity greater than 200 Btu/ft-hr-F.

6. The composite structure as claimed in claim 1, wherein the hard and thermally conductive members are adhesively bonded together.

7. The composite structure as claimed in claim 1, wherein a hard member presents the lowermost layer.

8. The composite structure as claimed in claim 7, wherein said at least one opening extends through at least a portion of each layer except the uppermost and lowermost layers.

9. The composite structure as claimed in claim 1, wherein said at least one opening extends through at least a portion of each layer except the uppermost layer.

10. The composite structure as claimed in claim 1, wherein the opening is spaced from the second top surface.

11. The composite structure as claimed in claim 1, wherein the opening presents first and second distal ends and is spaced from the edges of said at least one thermally conductive member, so that said at least one thermally conductive member further presents structural ligaments adjacent the distal ends.

12. The composite structure as claimed in claim 1, wherein the opening is dissevered and traversed by at least one intermediate structural ligament defined by the thermally conductive member.

13. The composite structure as claimed in claim 1, wherein the openings are filled with an insulative material.

14. The composite structure as claimed in claim 13, wherein the openings are filled with a material selected from the group consisting essentially of low thermal conductive metals, fiberglass, ceramic, silica fibers, fabrics and cloths.

15. The composite structure as claimed in claim 1, wherein a splash-guard orthogonally extends from side and rear edges defined by the uppermost surface, and the splash-guard and uppermost surface are integrally formed.

16. A composite cooking structure adapted for use as a griddle top, and presenting a plurality of thermally autonomous cooking zones when engaged by at least one heat source, said structure comprising:
at least one hard planar members each presenting first top and bottom major surfaces separated by a first thickness between 0.03 to 0.09 inches, and having a first thermal conductivity rate; and
at least one unitary thermally conductive planar member presenting second top and bottom major surfaces separated by a second thickness greater than the first thickness, having a second thermal conductivity rate greater than the first rate, and defining a plurality of elongated openings presenting a minimum depth at least 50 percent of the second thickness,
said hard and thermally conductive members being adjacently reposed and metallurgically bonded together, so as to form superjacent major layers having an uppermost and a lowermost surface, wherein the top surface of each of said at least one thermally conductive planar member contacts and engages the bottom surface of an aloftly adjacent hard member,
said openings being filled with an insulative material, spaced apart and longitudinally configured to generally produce a plurality of thermally separated sections of said at least one thermally conductive member, such that said at least one heat source is able to separately engage the sections.

17. A method of constructing a composite structure adapted for use as a griddle top, said method comprising the steps of:
a. securing a first stainless steel sheet presenting first top and bottom major surfaces spaced by a first thickness;
b. machining at least one elongated opening within a thermally conductive planar member defining second top and bottom major surfaces spaced by a second thickness greater than the first thickness, wherein the opening presents a depth at least 75 percent of the second thickness;
c. securing the thermally conductive planar member adjacent the sheet such that the second top major surface engages and forms superjacent layers with the first bottom surface; and
d. securing a second stainless steel sheet presenting third top and bottom major surfaces spaced by a third thickness equal to the first thickness adjacent the member such that the third top surface engages and forms superjacent layers with the second bottom surface.

18. The method as claimed in claim 17, wherein steps a), c) and d) further include the steps of roll bonding the first sheet to the member, and the first sheet and member to the second sheet, so as to form metallurgic bonds between the second top surface and first bottom surface and the third top surface and second bottom surface.

19. The method as claimed in claim 17, wherein step b) further includes the steps of boring a through-hole within the thermally conductive member, so that the opening is spaced from the second top and bottom surfaces.

20. The method as claimed in claim 17, wherein step b) further includes the steps of machining a plurality of end-to-end openings sharing a common longitudinal axis, where the openings are spaced so as to present at least one intermediate structural ligament.
